(19) United States
(12) Patent Application Publication
(10) Pub. No.: US 2015/0363274 A1
(43) Pub. Date: Dec. 17, 2015

(54) STORING BACKUP DATA SEPARATE FROM CATALOG DATA

(71) Applicants: Mandar Govind NANIVADEKAR, Bangalore, Karnataka (IN); Shishir MISRA, Bangalore, Karnataka (IN); Albrecht SCHROTH, Boeblingen (DE); HEWLETT-PACKARD DEVELOPMENT COMPANY, L.P., Houston, TX (US)

(72) Inventors: Mandar Nanivadekar, Bangalore (IN); Shishir Misra, Bangalore (IN); Albrecht Schroth, Boeblingen (DE)

(21) Appl. No.: 14/764,991

(22) PCT Filed: Feb. 1, 2013
(86) PCT No.: PCT/IN2013/000067

§ 371 Date: Jul. 31, 2015

(51) Int. Cl. G06F 11/14

(52) U.S. Cl. CPC G06F 11/1458; G06F 2201/84

(57) ABSTRACT

Techniques for storing backup data separate from catalog data are described in various implementations. An example method that implements the techniques may include receiving backup data that is to be backed up on a tape medium. The method may also include causing the backup data to be written to a first tape medium. The method may also include generating catalog data associated with the backup data, the catalog data including position information indicating where the backup data is stored on the first tape medium. The method may also include causing the catalog data to be written to a second tape medium that is different from the first tape medium.

### BACKGROUND

Many companies place a high priority on the protection of data. In the business world, the data that a company collects and uses is often the company's most important asset, and even a relatively small loss of data or data outage may have a significant impact. In addition, companies are often required to safeguard their data in a manner that complies with various data protection regulations. As a result, many companies have made sizeable investments in data protection and data protection strategies.

As one part of a data protection strategy, many companies perform backups of portions or all of their data. Data backups may be executed on an as-needed basis, but more typically are scheduled to execute on a recurring basis (e.g., nightly, weekly, or the like). Such data backups may serve different purposes. For example, one purpose may be to allow for the recovery of data that has been lost or corrupted. Another purpose may be to allow for the recovery of data from an earlier time—e.g., to restore previous versions of files and/or to restore a last known good configuration.

### BRIEF DESCRIPTION OF THE DRAWINGS

FIG. 1 shows a conceptual diagram of an example backup environment in accordance with implementations described herein.

FIG. 2 shows a flow diagram of an example process for storing backup data separate from catalog data in accordance with implementations described herein.

FIG. 3 shows a conceptual diagram of example tape media in accordance with implementations described herein.

FIG. 4 shows a conceptual diagram of example tape media in accordance with implementations described herein.

FIG. 5 shows a flow diagram of an example process for restoring backed up data in accordance with implementations described herein.

FIG. 6 shows a block diagram of an example system in accordance with implementations described herein.

### DETAILED DESCRIPTION

A backup system may protect vital data, e.g., in a datacenter, by storing the data in a persistent destination store. The destination store may include single or multiple storage devices of similar or disparate storage types, such as tape devices, tape libraries, or disk devices (local and/or network-based). Such destination stores may allow for the backup of large amounts of customer data that is backed up, e.g., from file systems, database servers, application servers, or the like.

Tape-based systems have traditionally been used to store large amounts of data that may be needed for long periods of time after the backup has occurred—e.g., data that may need to be restored up to ten, twenty, or even thirty or more years after the original backup. Tape backups may also be used for shorter-term storage. Backing up data to tape media may offer a number of advantages when compared to disk-based storage, such as robustness and portability of the tape media, lower cost per unit of storage, and energy savings. A typical LTO-6 tape medium can store between 2.5 and 6.25 terabytes of data, depending on the compression that is used.

Tape drives write data sequentially onto a tape medium using appropriate block sizes (e.g., 64 KB, 128 KB, etc.). During backup, data is read from a data source and is typically split and packed into a structure of appropriate block sizes before being written to the tape medium. During restoration, the data is read sequentially from the tape medium, and may then be unpacked and consumed by the backup application. Tape storage may be relatively fast for sequentially accessing data, but may be relatively slow for random access because the tape medium needs to be forwarded, rewound, or otherwise repositioned to a particular location on the tape medium where the desired data is stored.

In order to access data associated with a backed up element, or to restore a particular backed up element, the position of the backed up element on the storage medium needs to be known. Tape storage generally does not offer a file system, and as such, a backup application may generate a catalog that can be used during restore operations, export/import operations, or reporting operations associated with the backed up data. The catalog may include a variety of appropriate information, including for example, file names, file attributes, and/or storage locations (e.g., particular storage positions on particular storage media) associated with the backed up elements.

The catalog may be stored in a central repository that is accessible by the backup application, and that may allow the backup application to quickly access the appropriate information, e.g., to restore a particular backed up element from a backup tape where the element is stored. The repository may be particularly useful for accessing information about data that has been backed up relatively recently. But over time, the information about a particular backed up element may no longer be available in the repository. For example, in some cases, such as when the tape media has been moved from one datacenter to another, or when the tape media has otherwise been moved offsite (e.g., for storage in a vault), or when the repository has been corrupted, the repository may no longer contain the information required to locate and/or access a particular backed up element.

The catalog may also or alternatively be stored in segments that are written to the tape medium where the backup data is being written. For example, during backup, the backup application may generate catalog data about the backup data that is being written to the tape medium, and after a certain amount of backup data has been written in a backup data segment, the backup application may write a catalog data segment that describes where in the previous backup data segment each element is stored. Such processing may result in a tape medium having alternating segments of backup data and associated catalog data, where the backup data segments may be relatively large (e.g., on the order of multiple gigabytes) and the associated catalog data segments may be relatively small (e.g., on the order of megabytes).

In cases where the catalog data is stored on the same tape medium as the backup data, a single backup session catalog (e.g., all of the various segments of catalog data written during the backup session) may be spread across the entire medium, or may be spread across multiple tape media. During catalog access, e.g., for restoration, import/export, or reporting purposes, the tape medium (or media) is repeatedly forwarded and positioned to capture the various embedded catalog data segments, which are often very small. Such repeated starting and stopping of the tape media may reduce the useable life of the media as well as the tape drive head. Also, in cases where the catalog data is spread across multiple tape media, additional time may be required to read the catalog data due to time spent loading and unloading the tape media into the tape drives.

According to the techniques described here, the catalog data and the backup data may be stored separately on different tape media. For example, during a backup operation, a backup application may cause the data that is to be backed up to be read from a data source, and may cause the backup data to be written to a first tape medium. During the backup operation, the backup application may generate catalog data associated with the backup data, and may cause the catalog data to be written to a second tape medium. Such processing may, in some cases, result in a first tape medium having backup data written sequentially without any intervening catalog data segments and in a second tape medium having catalog data written sequentially without any intervening backup data segments.

The techniques described here may be used, for example, to reduce backup catalog processing times and the overall wear and tear on tape drives and associated media. For example, in some implementations, an entire backup catalog may be restored by simply reading a tape medium sequentially from the beginning of the catalog data to the end. In addition, the techniques may allow for asynchronous processing and improved management of catalog data in a datacenter. Furthermore, the chances of data loss due to catalog corruption may be reduced. These and other possible benefits and advantages will be apparent from the figures and from the description that follows.

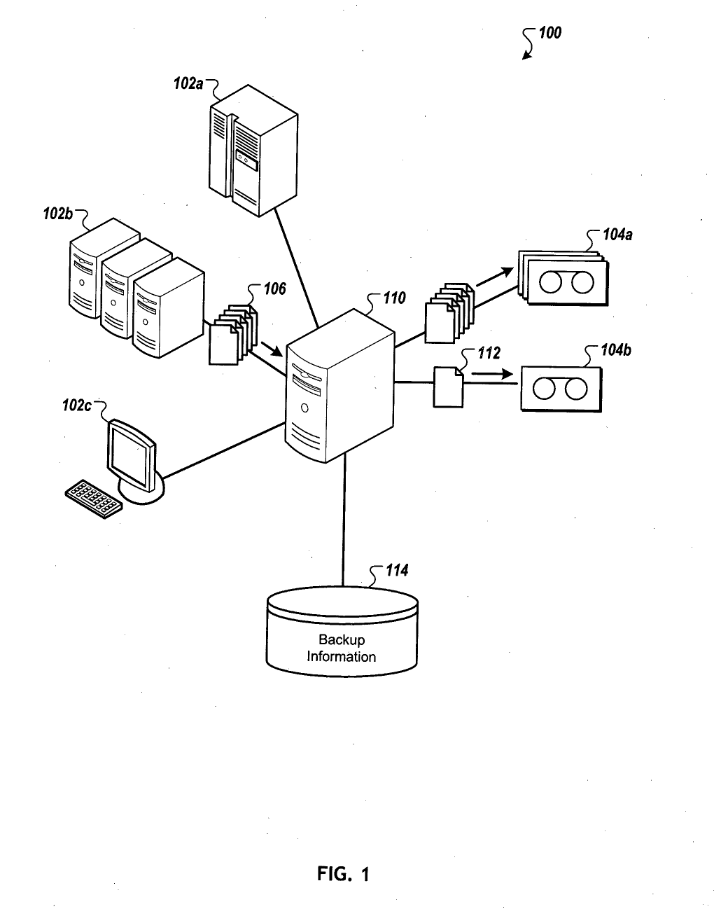

FIG. 1 shows a conceptual diagram of an example backup environment 100. Environment 100 may include multiple data sources 102a, 102b, and 102c, and may also include multiple tape-based backup devices 104a and 104b. The multiple data sources 102a-102c may be communicatively coupled to the multiple tape-based backup devices 104a and 104b via a backup management computing device 110, which may be configured to control and manage the backup/restore process. The various computing devices may be interconnected through one or more appropriate networks. The example topology of environment 100 may provide data backup capabilities representative of various backup environments. However, it should be understood that the example topology is shown for illustrative purposes only, and that various modifications may be made to the configuration. For example, backup environment 100 may include different or additional devices and/or components, or the devices and/or components may be connected in a different manner than is shown.

Data sources 102a-102c need not all be of the same type. Indeed, in many environments, data sources 102a-102c will typically vary in type. For example, in an enterprise environment, data sources 102a-102c might take the form of database server clusters, application servers, content servers, email servers, desktop computers, laptop computers, and the like. Similarly, backup devices 104a and 104b may vary in type. In the example shown, backup device 104a is shown as a tape library, and backup device 104b is shown as a standalone tape drive. However, it should be understood that other appropriate configurations may also be used.

In some environments, a source agent component may execute on each of the data sources 102a-102c, and a media agent component may execute on the backup management computing device 110. The source agent component may be responsible for reading the data from the host device as specified in a backup policy. The data to be backed up may include specific files, file systems, databases, email/file/web servers, or any other appropriate type of data. The media agent component may be responsible for accepting the data from the source agent component and writing it to a destination backup device and/or backup medium.

In some implementations, the source agent component itself may be responsible for writing the data directly to the backup devices, rather than routing the data via the backup management computing device 110. In such cases, the host computing devices may include the functionality for storing backup data separate from catalog data in accordance with the techniques described here. Similarly, in these or other implementations, the source agent component and the media agent component may be independent from a central backup management entity, and the agents may be controlled and managed independently, e.g., by a backup/restore graphical user interface (GUI).

In the example shown, a source agent executing on data source 102b reads the data to be backed up, e.g., as specified in a backup policy. The source agent then sends a copy of the backup data 106 to the backup management computing device 110. The backup management computing device 110 then causes the backup data 106 to be written to a first tape medium, e.g., to a tape medium in tape library 104a.

As the backup data 106 is being written to the first tape medium, or after such backup data 106 has been written, the backup management computing device 110 may generate catalog data 112 associated with the backup data 106. The catalog data 112 may include a number of details about the backup data 106, including for example, file names, file attributes, position information that indicates where the backup data 106 is being stored on the first tape medium, and/or other appropriate metadata about the backup data 106. Such catalog data 112 may be written to a backup information repository 114 that is accessible by the backup management computing device 110. In some implementations, the catalog data 112 stored in the backup information repository 114 may also be exported, e.g., automatically, when the associated backup data 106 is exported from the datacenter (e.g., for storage in a vault or for other purposes).

The catalog data 112 generated by the backup management computing device 110 may also be written to a separate, second tape medium, e.g., by tape device 104b. When writing the catalog data 112 to the second tape medium, the catalog data may be written in an uncompressed and/or unencrypted format, or may alternatively be compressed and/or encrypted, e.g., using hardware and/or software encryption as appropriate. The result of such processing is that catalog data is stored on a tape medium that is separate from the tape medium that stores the associated backup data.

In some implementations, to ensure that the backup data may subsequently be re-linked with its associated catalog data, an indicator may be written to the tape medium that stores the backup data. The indicator may identify the tape medium (or media) that stores the associated catalog data, e.g., by including a pointer or other reference to the tape medium storing the associated catalog data. In practice, when a backup data tape medium is loaded for restoration of such data, the indicator may identify the appropriate catalog data tape medium (or media), and the backup application may restore the catalog associated with the backup data by loading the appropriate catalog data tape medium, and generating the catalog based on the catalog data stored on the catalog data tape medium.

A number of different associative techniques may be used to ensure that the catalog media may be appropriately identified, e.g., by a backup application that is being used to consume the backed up catalog and data. For example, the backup information repository 114 may store information identifying the contents of the catalog tape media such that the backup application may locate an appropriate catalog medium for reading or writing the catalog. In addition, or alternatively, the backup application may utilize other appropriate mechanisms, e.g., to ensure that the backup information repository does not become a single point of failure. For example, bar codes may be attached to the catalog media, or an indicator may be written to the catalog media itself. The indicator written to the catalog media may be in the form of an encrypted identification pattern written to a persistent FLASH memory associated with the tape medium, or may be written to the start and/or end of the medium. These or other appropriate marking mechanisms may be used, and may be useful, e.g., when an entire library is exported to another datacenter.

In some implementations, the backup management computing device 110 may reserve a tape medium, or a set of tape media, exclusively for catalog backup so that only catalog data is stored on the reserved tape medium (or media). For example, when a particular tape library is accessed for the first time, a backup application may reserve a single tape medium that is only to be used for storing catalog data. The backup application may also reserve more than one medium, e.g., depending on the size of the data being backed up or on a policy that requires multiple reserved media to ensure that that library does not run out of storage space for the catalog data. Then, as the reserved tape medium (or media) are becoming full with catalog data, subsequent media may be reserved for storing additional catalog data.

The reserved tape media may be associated with a tape library or with a standalone tape drive. In addition, the backup application may identify and reserve a small tape library or standalone tape drive within a particular datacenter to be dedicated to storing/retrieving catalog information. In some implementations, a tape library may be partitioned such that the single tape library is seen as two different tape libraries, each having its own set of tape media. In such implementations, one of the partitions may be used exclusively for storing the catalog data, while the other partition may be used for storing the backup data.

In cases where separate tape drives are used to store the catalog data separately from the backup data, the catalog data may be written to the catalog data tape medium concurrently with the backup data being written to the backup data tape medium. In such cases, the catalog data that is being generated by the backup management computing device 110 may be written as it is generated, or may be stored in memory until a particular size or memory allocation has been reached, and then be written to the catalog data tape medium. All the while, the backup data may continue to be written to the backup data tape medium, uninterrupted by the processing and writing of the catalog data.

In some implementations, after the catalog data has been written to separate media, the catalog data may also be replicated or mirrored to duplicate media, either in the same location or in a separate location. For example, the catalog data media may be replicated to another catalog store within the same library, to another catalog store in another library, or to another catalog store in a different datacenter. In some cases, such replication may enable the proactive migration of at-risk catalog data to a more reliable store, e.g., by monitoring the health of the catalog tape media and/or the health of available tape media for catalog data storage, and selecting an appropriate medium for replicating the catalog data based on the monitored health conditions. Replication of the catalog data may take place while reading or writing operation are in progress, or can be performed asynchronously and independently of reading or writing operations, e.g., at a time when the datacenter and the tape library are not busy.

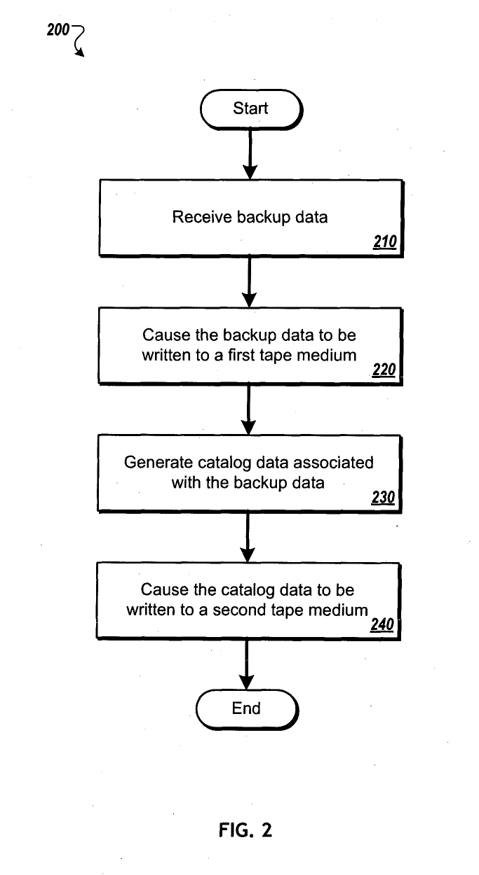

FIG. 2 shows a flow diagram of an example process 200 for storing backup data separate from catalog data. The process 200 may be performed, for example, by a backup management system, such as backup management computing device 110 illustrated in FIG. 1. For clarity of presentation, the description that follows uses the backup management computing device 110 as the basis of an example for describing the process. However, it should be understood that another system, or combination of systems, may be used to perform the process or various portions of the process.

Process 200 begins at block 210, in which backup data is received. For example, the backup management computing device 110 may receive, from a source device, data that is to be backed up (e.g., files, file systems, databases, etc.) on a tape medium.

At block 220, the backup data is caused to be written to a first tape medium. For example, the backup management computing device 110 may cause the backup data to be written to a tape medium using a tape drive of a tape library or using a standalone tape drive. In addition to the backup data, an indicator that identifies a second tape medium where the associated catalog data will be stored may also be written to the first tape medium.

At block 230, catalog data associated with the backup data is generated. For example, the backup management computing device 110 may extract certain information about the backup data that is being written to the first tape medium, and such information may be stored as catalog data that is associated with the backup data. The catalog data may include, for example, file names, file attributes, positioning information that indicates where the backup data is stored on the first tape medium, and/or any other appropriate metadata associated with the backup data.

At block 240, the catalog data is caused to be written to a second tape medium that is different from the first tape medium. For example, the backup management computing device 110 may cause the catalog data to be written to a separate tape medium using a tape drive of a tape library or using a standalone tape drive.

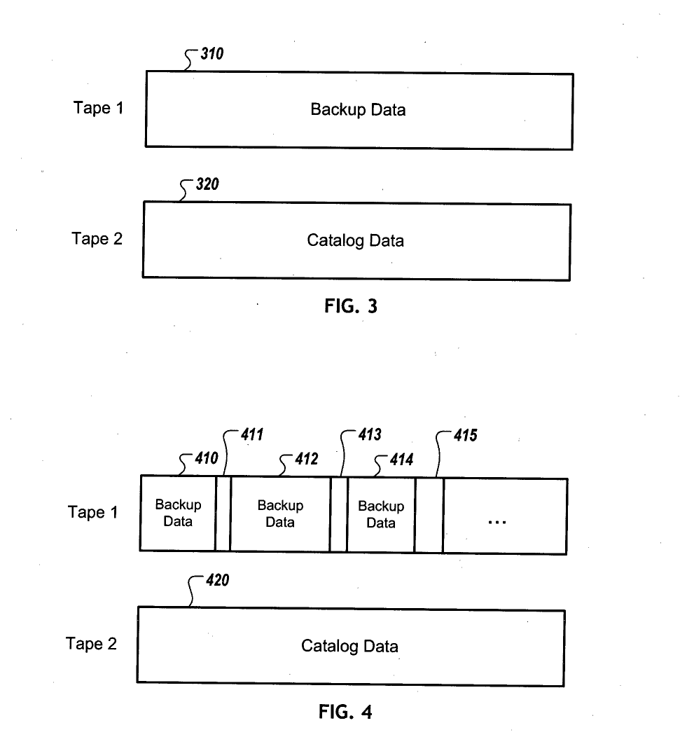

FIGS. 3 and 4 show conceptual diagrams of example tape media. In FIG. 3, a first tape (Tape 1) is used to store only backup data 310. As shown, the backup data 310 is written in a sequential manner such that the backup data may be read back as a continuous segment of data without repeatedly forwarding or otherwise re-positioning the tape media to read separate backup data segments. A second tape (Tape 2) is used to store only catalog data 320. As shown, the catalog data 320 is written in a sequential manner such that the catalog data may be read back as a continuous segment of data without repeatedly forwarding or otherwise re-positioning the tape media to read separate catalog data segments.

In FIG. 4, the second tape (Tape 2) is the same as in FIG. 3, where the second tape is used to store only catalog data 420. As shown, the catalog data 420 is written in a sequential manner such that the catalog data may be read back as a continuous segment of data without repeatedly forwarding or otherwise re-positioning the tape media to read separate catalog data segments. But, as an alternative to FIG. 3, the first tape (Tape 1) in FIG. 4 is used to store backup data as well as a redundant copy of the catalog data. The backup data is written in segments 410, 412, and 414, and the catalog data is written in segments 411, 413, and 415 that are interleaved with the backup data segments. For example, during backup, the backup application may generate catalog data about the backup data that is being written to the tape medium, and after a certain amount of backup data has been written in a backup data segment, the backup application may write a catalog data segment that describes where in the previous backup data segment each element is stored. Such processing results in a tape medium having alternating segments of backup data and associated catalog data, where the backup data segments may be relatively large (e.g., on the order of multiple gigabytes) and the associated catalog data segments may be relatively small (e.g., on the order of megabytes).

The configuration of FIG. 4 offers an extra layer of redundancy such that, even if the second tape (Tape 2) is lost, corrupted, or otherwise unavailable, the catalog may be restored using the catalog data stored on the first tape (Tape 1). When using such a configuration, the backup application may first attempt to restore the catalog using the sequentially-stored catalog data (from Tape 2), but if Tape 2 is unavailable, then the backup application may restore the catalog using the separate, interleaved catalog data segments stored on Tape 1. Although restoration from Tape 2 would offer greater efficiency (and thus attempted first), restoration from Tape 1 would still be available as a backup if Tape 2 could not be used for whatever reason.

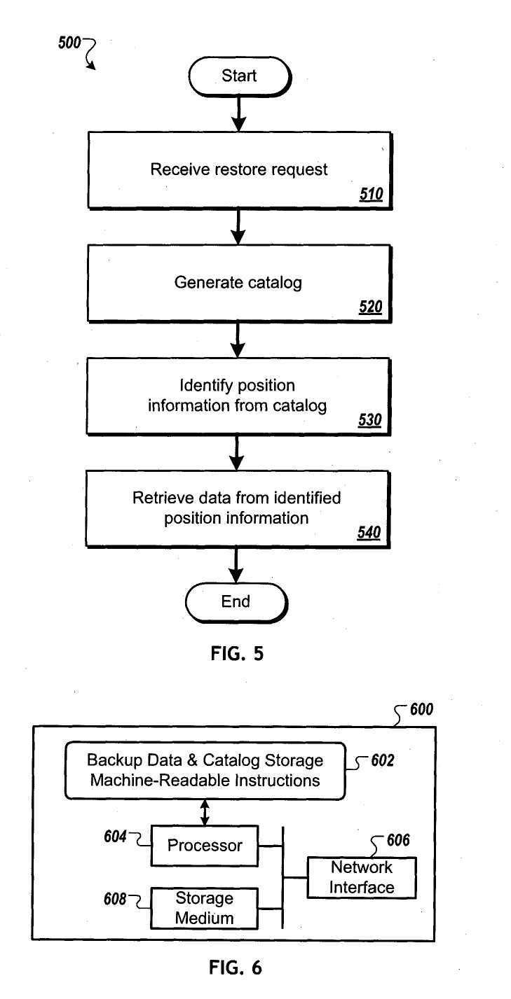

FIG. 5 shows a flow diagram of an example process 500 for restoring backed up data. The process 500 may be performed, for example, by a backup management system, such as backup management computing device 110 illustrated in FIG. 1. For clarity of presentation, the description that follows uses the backup management computing device 110 as the basis of an example for describing the process. However, it should be understood that another system, or combination of systems, may be used to perform the process or various portions of the process.

Process 500 begins at block 510, in which a restore request is received. For example, the backup management computing device 110 may receive a request to restore all or a portion of data that had previously been backed up (e.g., files, file systems, databases, etc.) on a tape medium.

At block 520, a catalog may be generated from the catalog data. The catalog may be used, for example, during restore operations, export/import operations, or reporting operations associated with the backed up data. The catalog may include a variety of appropriate information, including for example, file names, file attributes, and/or storage locations (e.g., particular storage positions on particular storage media) associated with the backed up data.

In some cases, the backup management computing device 110 may generate the catalog from a catalog data tape medium that stores only catalog data (e.g., Tape 2 in both FIGS. 3 and 4). In such cases, the backup management computing device 110 may generate the catalog by reading the catalog data from the catalog data tape medium (or media) in a sequential manner without skipping to a different portion of the tape. In other words, the catalog data may be read from start to finish without re-positioning the tape medium.

At block 530, the position information associated with the portion of data to be restored may be identified from the generated catalog. For example, the position information may identify a specific backup data tape medium and a specific location on that tape where the requested data is stored. Then, the data may be retrieved from the identified position information at block 540.

FIG. 6 shows a block diagram of an example system 600, which may be representative of the computing devices of FIG. 1. The system 600 includes backup data and catalog storage machine-readable instructions 602, which may include certain of the various modules of the computing devices depicted in FIG. 1. The backup data and catalog storage machine-readable instructions 602 are loaded for execution on a processor or processors 604. A processor can include a microprocessor, microcontroller, processor module or subsystem, programmable integrated circuit, programmable gate array, or another control or computing device. The processor(s) 604 can be coupled to a network interface 606 (to allow the system 600 to perform communications over a data network) and a storage medium (or storage media) 608.

The storage medium 608 can be implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other appropriate types of storage devices. Note that the instructions discussed above can be provided on one computer-readable or machine-readable storage medium, or alternatively, can be provided on multiple computer-readable or machine-readable storage media distributed in a system having possibly plural nodes. Such computer-readable or machine-readable storage medium or media is (are) considered to be part of an article (or article of manufacture). An article or article of manufacture can refer to any appropriate manufactured component or multiple components. The storage medium or media can be located either in the machine running the machine-readable instructions, or located at a remote site, e.g., from which the machine-readable instructions can be downloaded over a network for execution.

Although a few implementations have been described in detail above, other modifications are possible. For example, the logic flows depicted in the figures may not require the particular order shown, or sequential order, to achieve desirable results. In addition, other steps may be provided, or steps may be eliminated, from the described flows. Similarly, other components may be added to, or removed from, the described systems. Accordingly, other implementations are within the scope of the following claims.

What is claimed is:

1. A method for storing backup data separate from catalog data, the method comprising:
receiving, at a computing device and from a source device, backup data that is to be backed up on a tape medium;
causing, using the computing device, the backup data to be written to a first tape medium;
generating, using the computing device, catalog data associated with the backup data, the catalog data including position information indicating where the backup data is stored on the first tape medium; and
causing, using the computing device, the catalog data to be written to a second tape medium that is different from the first tape medium.

2. The method of claim 1, wherein the catalog data is written to the second tape medium concurrently with the backup data being written to the first tape medium.

3. The method of claim 1, further comprising causing an indicator to be written to the first tape medium, the indicator identifying the second tape medium as storing the catalog data associated with the backup data.

4. The method of claim 1, wherein restoring a portion of the backup data comprises generating a catalog based on the catalog data stored on the second tape medium, and identifying from the catalog the position information associated with the portion of the backup data.

5. The method of claim 4, wherein the catalog is generated by reading the catalog data from the second tape medium in a sequential manner without skipping to a different portion of the second tape medium.

6. The method of claim 1, further comprising causing segments of the catalog data to be written to the first tape medium between segments of the backup data.

7. The method of claim 6, wherein restoring a portion of the backup data comprises generating a catalog based on the catalog data stored on the second tape medium if the second tape medium is available, and otherwise generating the catalog based on the catalog data stored on the first tape medium.

8. The method of claim 1, wherein the second tape medium is reserved for catalog backup such that only catalog data is stored on the second tape medium.

9. A system for storing backup data separate from catalog data, the system comprising:
one or more processors;
a backup application executing on the one or more processors that receives backup data that is to be backed up on a tape medium;
a first tape device that writes the backup data to a first tape medium; and
a second tape device, different from the first tape device, that writes catalog data associated with the backup data to a second tape medium, different from the first tape medium, wherein the catalog data indicates where the backup data is stored on the first tape medium.

10. The system of claim 9, wherein the first tape device writes the backup data to the first tape medium concurrently with the second tape device writing the catalog data to the second tape medium.

11. The system of claim 9, wherein the backup application generates a catalog based on the catalog data stored on the second tape medium.

12. The system of claim 11, wherein the catalog data from the second tape medium is read in a sequential manner without skipping to a different portion of the second tape medium.

13. The system of claim 9, wherein the first tape device writes segments of the catalog data to the first tape medium between segments of the backup data.

14. The system of claim 13, wherein the backup application generates a catalog based on the catalog data stored on the second tape medium if available, and otherwise generates the catalog based on the catalog data stored on the first tape medium.

15. A non-transitory, computer-readable storage medium storing instructions for storing backup data separate from catalog data, the instructions when executed by one or more processors cause the one or more processors to:
receive backup data that is to be backed up on a tape medium;
generate catalog data associated with the backup data; and
cause the backup data and the catalog data to be written to separate tape media.
